(19) United States
(12) Patent Application Publication
(10) Pub. No.: US 2006/0216487 A1
(43) Pub. Date: Sep. 28, 2006

(54) Fluid guiding surfaces

(75) Inventor: Takayuki Fukui, Yokohama-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/377,928

(22) Filed: Mar. 16, 2006

(30) Foreign Application Priority Data
Mar. 17, 2005 (JP) 2005-076210

(51) Int. Cl. B32B 7/02

(52) U.S. Cl. 428/212; 427/256

(57) ABSTRACT

The fluid guiding surfaces of the present invention include a first elongate directional band A arranged substantially in parallel with a second elongate directional band B. Due to differences in physicochemical surface energy of the first and second bands, the contact angle of water on elongate directional band B may be smaller than the contact angle of water on elongate directional band A, thereby guiding fluid droplets along the surface in a direction parallel to elongate directional band B. For example, the difference ⁷⁴ _{A}−^{θ}_{B} between a first contact angle of water on elongate directional band A, and a second contact angle of water on elongate directional band B, is from about 10° to about 140°.

This application claims priority from Japanese Patent Application No. 2005-076210, filed Mar. 17, 2005, the entire contents of which are incorporated herein by reference.

### TECHNICAL FIELD

The invention relates to automotive surfaces, in particular to fluid guiding surfaces for automotive applications.

### BACKGROUND

In recent years, water repellent hydrophobic films and coatings, as well as hydrophilic films and coatings, have been applied to surfaces of automobiles, window glazings, textiles, clothing (especially rain gear), footwear, cookware, and other articles to control the adhesion and wetting of liquid (e.g. water) droplets on those surfaces.

For example, various water-repellent fluorocarbon resins have been applied to clothing to control wettability by increasing the contact angle between water-containing droplets and the cloth surface. Nevertheless, due to the polarity of fluorocarbon resins, it is difficult to loosen droplets from a clothing surface without application of an external force, and it is known that droplets may not necessarily lose adhesion to the surface unless the contact angle is large. In the technical field of electronic materials fabrication, water-repellent coatings are formed; for example as dots, matrices, and circuits; in manufacturing photosensitive masks, in semiconductor manufacturing processes, and in manufacturing integrated electronic circuit devices.

However, conventional water-repellent films or coatings have a problem as a practical matter, because these water-repellent surfaces are directed at controlling droplet wettability on planar surfaces at a microscopic level, and do not control bulk movement of macroscopic fluid droplets on a macroscopic scale. The art continually searches for new methods of controlling droplet wettability and bulk fluid motion on surfaces, particularly for water droplets on non-porous surfaces such as metal and glass.

### SUMMARY

In general, the invention is directed to a surface treatment and fluid guiding surface adapted to control the direction of movement of droplets on the surface of material bodies, and particularly to fluid guiding surfaces for use in water-repellent automotive glass and automotive coatings. The invention provides a drop-guiding surface for improving the transfer rate of raindrops from automotive glass.

The fluid guiding surface of the present invention comprises a surface having a first elongate directional band A proximate a second elongate directional band B. The contact angle of water on elongate directional band B may be smaller than that on elongate directional band A, and the transfer rate of raindrops may be improved by setting the difference in these contact angles to a prescribed value. In some embodiments, the fluid guiding surface of elongate directional band A and the fluid guiding surface of elongate directional band B are preferably arranged substantially in parallel, and most preferably are arranged in parallel.

In addition, the elongate directional band A and elongate directional band B may satisfy the relationship described in the following expression:
^{θ}_{A}-^{θ}B=10°-140°
wherein ^{θ}_{A} and ^{θ}_{B} are the contact angles of water on the surface of elongate directional bands A and B, respectively, at 20° C.

According to the present invention, because the difference in these contact angles is set as the prescribed value, it is possible to provide a fluid guiding surface that controls the direction of movement of droplets on the surface of material bodies, and especially the preferred fluid guiding surface for use in water-repellent automotive glass and automotive coatings.

In one embodiment, a fluid guiding surface comprises a first elongate directional band A on a substrate, wherein a surface energy of a surface of the first elongate directional band A exhibits a first water contact angle ⁷⁴_{A} at 20° C. The fluid guiding surface further comprises a second elongate directional band B proximate the first elongate directional band A on the substrate, wherein a surface energy of a surface of the second elongate directional band B exhibits a second water contact angle ^{θ}_{B} at 20° C. The difference ^{θ}_{A}-⁷⁴ _{B} between the first water contact angle on the surface of directional band A and the second water contact angle on the surface of directional band B is between 10°-140°.

In another embodiment, a fluid guiding surface includes a plurality of elongate directional bands A positioned on a surface of a substrate, wherein a surface energy of the surface of the elongate directional bands A is such that water exhibits a first contact angle ^{θ}_{A} at 20° C. The fluid guiding surface further includes a plurality of elongate directional bands B positioned on the surface of the substrate, wherein each elongate directional band B is positioned adjacent to at least one of the elongate directional bands A to form an arrangement of alternating directional bands A and B, and wherein a surface energy of the surface of the elongate directional bands B is such that water exhibits a second contact angle ^{θ}_{B} on directional band B at 20° C. The difference ^{θ}_{A}-⁷⁴ _{B} between the first contact angle of water on directional bands A and the second contact angle of water on directional bands B is from about 10° to about 140°.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A-1D are block diagrams illustrating examples of the flat pattern of a fluid guiding surface in accordance with an exemplary embodiment of the invention.

FIGS. 2A-2C are perspective diagrams illustrating examples of the fluid guiding surface according to another exemplary embodiment of the invention in which a elongate directional band is formed by means of a thin film.

FIGS. 3A-3D are perspective diagrams illustrating examples of the fluid guiding surface according to an additional exemplary embodiment of the invention in which an elongate directional band is formed by a relief structure on the surface.

FIG. 4 is a perspective diagram that shows an exemplary fluid guiding surface in accordance with a further exemplary embodiment of the invention in which an elongate directional band is formed by a thin film having a surface relief structure.

### DETAILED DESCRIPTION

The fluid guiding surface of the present invention is explained in detail below. In exemplary embodiments, the fluid guiding surface of the present invention includes a first elongate directional band A arranged adjacent to and substantially parallel with a second elongate directional band B. Due to differences in physicochemical surface energy of the surfaces of the first and second elongate directional band regions, the contact angle of water on elongate directional band B may be smaller than the contact angle of water on elongate directional band A. As a result, the mass transfer rate of raindrops off of the surface may be improved by setting the difference in these contact angles to a prescribed value that promotes spontaneous spreading or wicking of the droplets in a direction substantially parallel to elongate directional band B.

In this way and by use of a configuration in which elongate directional band A and elongate directional band B are arranged adjacent to and substantially parallel with each other, it is possible to control the direction of movement of the droplets. In certain preferred embodiments, elongate directional band A and elongate directional band B are attached along the entire length of each band in a configuration in which the lengths are even.

In some embodiments, each of elongate directional bands A and B exhibit generally rectangular shapes having a long dimension and a short dimension. Furthermore, when arranging the elongate directional bands A and B in parallel, it is preferable to arrange elongate directional band A and elongate directional band B in an alternating configuration across the entire width of the surface, with the long dimension of each band running parallel to the desired direction of fluid movement. By orienting the long direction of each band parallel to the desired direction of fluid movement, it is possible to control the direction of droplet motion to the desired direction. Moreover, when applying this type of fluid guiding surface to the surface of a car body, the direction in which raindrops flow along the surface can be controlled, thus making it possible to prevent rain streaks on the body surface.

Furthermore, the surface energy of the first elongate directional band A is such that water exhibits a first contact angle on directional band A (^{θ}_{A}) at 20° C., and the surface energy of the second elongate directional band B is such that water exhibits a second, lower contact angle on directional band B (^{θ}_{B}) at 20° C. The difference ^{θ}_{A}-^{θ}_{B} between the first contact angle of water on directional band and the second contact angle of water on directional band is from about 10° to about 140°. In other words, the fluid guiding surface of the present invention requires that elongate directional band A and elongate directional band B satisfy the relationship in the following expression.
(^{θ}_{A}-^{θ}_{B})=10°-140° (1)
wherein θ_{A} and θ_{B} represent the contact angle of water on the elongate directional bands A and B, respectively, at 20° C.

For exemplary fluid guiding surfaces according to certain embodiments of the present invention, a difference in water contact angle of from about 30° to about 120° is desirable. In certain embodiments, a distribution or gradient of surface energies may be established within elongate directional band A and within elongate directional band B, and the contact angle within each directional band surface may be reduced from a higher value to a lower value according to the desired direction of droplet movement, for example, in the long axis direction. The gradient may be selected from virtually any variation in surface energy with distance from one end of the elongate band to the opposing end. In certain embodiments, the gradient may be selected to be a linear variation, a logarithmic variation, or an exponential variation with distance from one end of the elongate directional band.

The gradient in surface energy along the length of an elongate directional band may be produced in any number of ways. For example, by depositing a film or applying a coating material to the elongate directional bands in a manner that creates a variation in material composition, and thus a surface energy gradient from a high surface energy material to a low surface energy material (higher to lower contact angle), in moving in the desired fluid movement direction, droplets may be guided along the elongate directional bands in the desired direction. In certain embodiments, the film may be attached to the elongate directional bands by an adhesive. In certain preferred embodiments, the film or coating material is substantially transparent to visible light.

In one exemplary embodiment, a fluid guiding surface according to the present invention may be applied to a surface of a vehicle glazing material, for example, a surface of an automobile windshield. In applying the fluid guiding surface of the present invention to an automobile windshield, when the difference between the contact angles (^{θ}_{A}-^{θ}_{B}) is less than 10°, it may become difficult for the adhering liquid droplets to move in the desired direction under the force derived from the surface tension or surface energy gradient, due to the presence of an opposing force, for example, the wind-resistance arising from vehicle movement. Moreover, when the difference in the contact angle exceeds 140°, the increase in the driving force for bulk droplet motion derived from the surface energy gradient of directional bands A and B may be negligible, and the use of the fluid guiding surface under such conditions may not be cost effective.

While not wishing to be bound to any particular theory, applicants will now set forth their present understanding of the mechanism for droplet movement along the fluid guiding surfaces. In one exemplary fluid guiding surface according to the present invention, the water-containing droplets that adhere to the surface gather along or proximate to elongate directional band B, on which the contact angle of water is relatively smaller than the contact angle of water on elongate directional band A. The droplets then spontaneously spread along elongate directional band B in response to the difference in surface energies of elongate directional band B and A, as reflected by the difference in water contact angles determined for these surfaces.

In addition, in some embodiments the present invention includes elongate directional bands having a surface contour or relief structure able to use the difference in physicochemical surface energy along the surface to guide fluid movement in a desired direction. In some embodiments, use of a surface contour or surface structure may be particularly useful to guide fluid movement along curved surfaces, such as the curved surfaces of an automobile body. In certain other embodiments the surface may be flat, and it may not be necessary to incorporate a thin film having a surface contour or relief structure.

Furthermore, in certain preferred embodiments, the fluid may be guided along the pattern of elongate directional bands in the general direction of a surface energy gradient from a relatively higher value to a relatively lower value, for example, in the long direction of the bands. In certain embodiments, the fluid, in the form of droplets or a liquid film, moves in the desired direction under the surface tension force corresponding to the gradient in surface energy from a high to a low value, while simultaneously experiencing forces that may act to retard fluid movement in the desired direction, for example, external forces such as gravity and impinging air streams (e.g. wind). In such cases, it may be desirable to increase the magnitude of the gradient in surface energy, for example, by increasing the reduction in water contact angle exhibited by the surface of each elongate directional bands in moving along the long direction of the band in the desired direction of fluid movement.

Moreover, in the fluid guiding surface of the present invention, the polar component (^{γ}_{BS}) of the surface energy of elongate directional band B is preferably 10 mN/m or less when measured at 20° C. When ^{γ}_{BS} exceeds 10 mN/m, the transfer rate of droplets to elongate surface B may be insufficient to guide the fluid in the desired direction. The polar component of the surface tension (^{γ}_{BS}) may be determined using known computational methods. For example, with respect to an arbitrary solid surface, it is possible to express the solid surface energy (γ_{S}) using the following expression:
γ_{S}=γ_{aS}+γ_{BS}+γ_{CS} (2)
In the expression, γ_{aS} is the dispersion force component, γ_{BS} is the polar component, and γ_{CS} is the hydrogen-bonding component of the surface energy.

Furthermore, the surface tension (γ_{L}) of a bulk liquid can be expressed using the following expression:
γ_{L=γ}_{aL}+γ_{BL}+γ_{CL} (3)
In the expression, γ_{aL} is the dispersion force component, γ_{BL} is the polar component, and γ_{CL} is the hydrogen-bonding component of the liquid surface tension.

For a liquid droplet positioned on the solid surface, the following relationship describes the balance of surface energies at the solid/liquid/air interface:
2×[(γ_{aS}^{1/2}×γ_{aL}^{1/2})+(γ_{BS}^{1/2}×γ_{BL}^{1/2})+(γ^{1/2}×γ_{CL}^{1/2})]=(γ_{aL}+γ_{BL}+γ_{CL})×(1+cos θ) (4)
where θ is the liquid/solid contact angle.

In order to determine the surface energies of a solid surface from measured contact angles, it is necessary to determine contact angles of particular probe liquids on the surface. First, using alkanes (non-polar A-type probe liquids) such as n-hexane, n-heptane, n-octane, n-nonane, n-decane, n-undecane, n-dodecane, tetramethyhexadecane, trans-decaline, etc., having only the γ_{aL} component of liquid surface tension, the contact angle (θ_{aS}) may be measured and the γ_{aS} component of the solid surface may then be is calculated. In this case (using a non-polar A-type probe liquid), the following expression applies:
γ_{BL}=γ_{CL}=0 (5)
Therefore, for the case of a non-polar A-type probe liquid on the solid surface, expression (4) can be rearranged to calculate γ_{aS} from the measured contact angle (θ_{aS}) and the known (or measured) non-polar probe liquid surface tension (γ_{aL}) using the following expression:
γ_{aS}={γ_{aL}^{1/2}[(1+Cos θ_{aS})/2]}² (6)

The value of the polar component of the solid surface energy (γ_{BS}) may then be determined as follows. A second contact angle (θ_{BS}) may be measured using a polar probe liquid (e.g. a polar B-type probe liquid) such as methylene iodide, tetrabromoethane, α-bromonaphthalene, tricresylphosphate, tetrachloroethane, hexachlorobutadiene, and polydimethylsiloxane, having only a γ_{aL} component and γ_{BL} component, but no hydrogen-bonding component (γ_{CL}). The values of γ_{aS} and γ_{BS}, determined using the two measured contact angles corresponding to the non-polar probe fluid having known surface tension γ_{aL}, and the polar probe fluid having known (or measured) surface tension (γ_{aL}+γ_{BL}), may then be calculated.

Examples of materials for which the γ_{BS} calculated in this way is 10 mN/m or less include polytetrafluoroethylene, polytrifluoroethylene, polyvinyl, polyvinyl chloride, polyvinylidene chloride, polyethylene, polymethylmethacrylate, polyvinyl alcohol, polystyrene, polyethylene terephthalate, polyamide, polypropylene, polyoxymethylene or silicone series resins, as well as mixtures thereof.

In addition, a third contact angle (θ_{CS}) may be measured using a strong hydrogen bond-forming probe liquid (a hydrogen bonding C-type probe liquid) such as water, glycerin, formamide, thiodiglycol, ethylene glycol, diethylene glycol, polyethylene glycol, and dipropylene glycol, having a γ_{aL} component, a γ_{BL} component, and a γ_{CL} component of the liquid surface tension. Using the previously calculated values of the dispersion force component (γ_{aS}) and the polar component (γ_{BS}) of the solid surface energy, and the known probe liquid surface tension (γ_{aL}+γ_{BL}+γ_{CL}), the hydrogen-bonding component of solid surface energy (γ_{CS}) may be calculated.

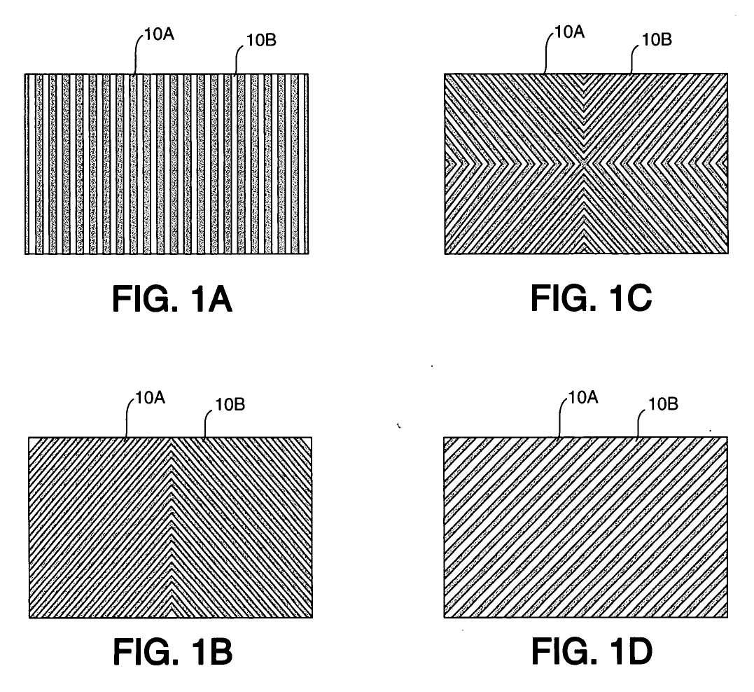

Various embodiments of the invention will now be described with reference to the figures. FIGS. 1A-1D are block diagrams illustrating examples of various patterns for fluid guiding surfaces in accordance with exemplary embodiments of the invention. As shown in FIGS. 1A-1D the fluid guiding surfaces include elongate directional bands 10A and elongate directional bands 10B on the surface 20. In certain embodiments, the flat pattern formed by elongate directional bands A and elongate directional bands B may be positioned such that the long direction of each band generally corresponds to the desired direction of fluid movement, with particular reference to the direction from which external forces such as gravity and wind may act upon the surface.

FIG. 1A illustrates a pattern in which elongate directional bands 10A and 10B are substantially rectangular bands having a long axis dimension and a short axis dimension positioned substantially perpendicular to the long axis dimension. FIG. 1A illustrates an exemplary configuration in which the long dimensions of each elongate directional band 10A and elongate directional band 10B are positioned substantially parallel to each other. FIG. 1 also illustrates an exemplary embodiment in which elongate directional bands 10A and 10B are positioned with their long dimension dimensions positioned adjacent to each other in an alternating arrangement.

Arbitrary patterns may be selected for the elongate directional bands to the extent that such patterns are effective in guiding fluid in a desired direction according to embodiments of the present invention. Although the elongate directional bands are shown in the figures as a generally rectangular shape, other shapes, for example triangular or trapezoidal, may also be used. As illustrated by FIGS. 1B-1C, the elongate directional bands 10A and 10B need not be rectangular in shape, and may be oriented in non-parallel arrangements (e.g. positioned at an angle with respect to each other), for example, in a V-shaped arrangement as illustrated by FIG. 1B, or in a X-shaped arrangement as illustrated by FIG. 1C. Moreover, the elongate directional bands 10A and 10B need not have a uniform long dimension, as illustrated by FIGS. 1B-1D.

Moreover, in the fluid guiding surface of the present invention, the bandwidth (pattern width in the short axis direction) of elongate directional bands A and B is not limited insomuch as it is effective in the present invention, and can be arbitrarily selected according to the size of the droplets adhering to the surface. For example, the typical size of raindrops adhering to automobiles are approximately 500 μm-10 mm, and when the bandwidth (pattern width in the short axis direction) exceeds 500 μm, it may be difficult to obtain the driving force attributed to surface tension, and the raindrops that accumulate within the pattern as microscopic droplets that do not flow as desired may remain.

Because the movement of droplets under the force of surface tension alone may, under certain circumstances where external forces such as gravity or wind are applied to the droplets, be insufficient to guide the liquid in the desired direction, it is preferable that the bandwidth (pattern width) of elongate directional bands A and/or elongate directional band B be about 500 μm or less, and considering the broadly distributed width of raindrops after raindrops adhere to the car body, it is preferable that they be about 200 μm or less, and further considering the fragmentation of raindrops after adherence, it is preferable that they be about 50 μm or less.

The relevant bandwidth (pattern width) need not be uniform along the long axis direction of the elongate directional bands. Various tapered bandwidths (pattern width) of elongate directional bands A and B may be used, to the extent that such patterns are effective in guiding fluid in a desired direction according to embodiments of the present invention. In some embodiments, it is preferred that the bandwidth of directional band B narrow in the direction of the desired fluid movement. If the bandwidth (pattern width) of elongate directional band B narrows in the desired direction of fluid movement, the bandwidth (pattern width) of elongate directional band A should generally broaden in the desired direction of fluid movement. In addition, elongate directional bands A and B may alternate or exchange positions for any of the embodiments illustrated in FIGS. 1A-1D.

Furthermore, in exemplary embodiments of the fluid guiding surface of the present invention, elongate directional bands A and/or elongate directional band B may be formed by a flat thin film, or elongate directional bands A and/or elongate directional band B may be formed by a relief structure. By building a microscopic relief structure on the surface, driving force can be obtained through surface tension and it is possible to control the direction of droplet movement.

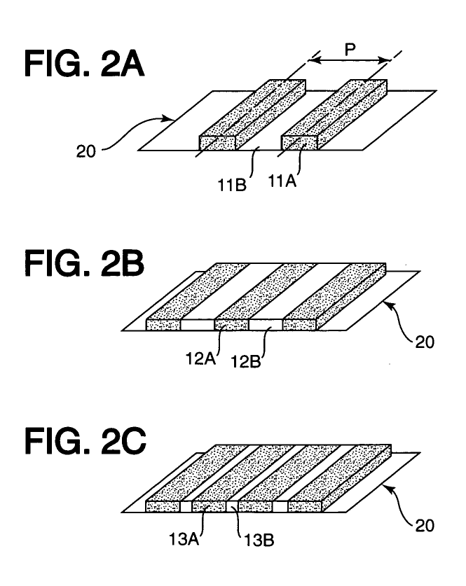

FIGS. 2A-2C are perspective diagrams illustrating examples of the fluid guiding surface according to an exemplary embodiment of the invention in which an elongate directional band is formed on a substrate or base by applying a thin film to the substrate or base surface. As shown in FIG. 2A, elongate directional bands A and B of the fluid guiding surface may, for example, be formed by applying elongate directional band A as a flat thin film 11A. In FIG. 2A the surface 11B of base 20, which does not have an applied thin film, corresponds to elongate directional band B.

Furthermore, as shown in FIG. 2B, both elongate directional band A and elongate directional band B may be formed by flat thin films 12A, 12B. Moreover, as shown in FIG. 2C, elongate directional bands A and elongate directional band A may both be formed by flat thin films 13A, 13B, and the bandwidth (pattern width) of thin film 13B may be made different from the bandwidth (pattern width) of thin film 13A, for example, bandwidth (pattern width) of thin film 13B may be made smaller than the bandwidth (pattern width) of thin film 13A, as shown in FIG. 2C.

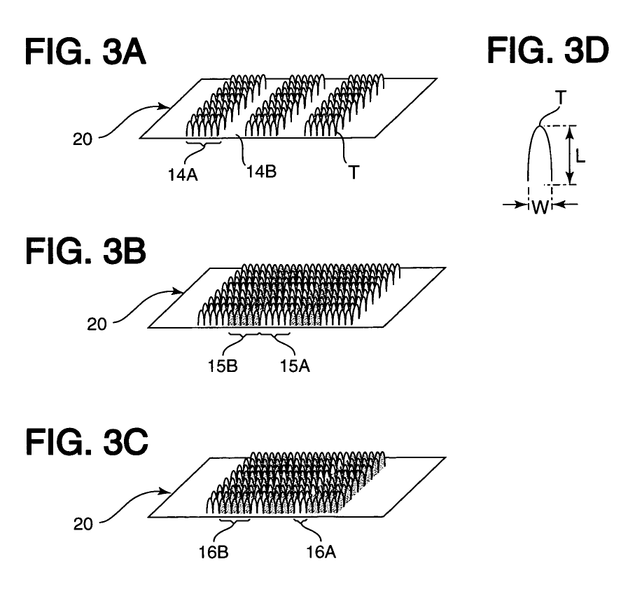

FIGS. 3A-3D are perspective diagrams illustrating examples of the fluid guiding surface according to an exemplary embodiment of the invention in which an elongate directional band is formed by means of a surface relief structure. As shown in FIG. 3A, it is possible to form a similar elongate directional band A by means of a surface relief structure 14A made from multiple convex portions T. In addition, in FIG. 3A, the surface 14B of base 20, which does not form a surface relief structure, corresponds to elongate directional band B.

As shown in FIG. 3B, both elongate directional bands A and elongate directional band B may be formed by surface relief structures 15A, 15B. As shown in FIG. 3C, both elongate directional bands A and elongate directional band B may be formed by relief structure 16A, 16B, and the bandwidth (pattern width) of relief structure 16A can be made different from the bandwidth (pattern width) of thin film 16B, for example, bandwidth (pattern width) of thin film 16A may be made smaller than the bandwidth (pattern width) of thin film 16B, as shown in FIG. 3C.

FIG. 3D is an expanded perspective view of a convex portion T. In FIG. 3D, the dimensional relationship of the convex portion T of the cross-section of the surface relief structure is illustrated. W represents a width of the convex portion T and L represents a height of the convex portion T. In certain embodiments of the present invention, the term “aspect ratio” refers to a ratio of (the depth of the concave portion or height of the convex portion, or the sum of the depth of the concave portion and the height of the convex portion when the concave portion and convex portion are adjoining)/(the length between the fluid directing surfaces attached to the surface (basic surface) of the concave portion or convex portion). This ratio corresponds to the height to width (L/W) ratio of convex portion T in FIG. 3D.

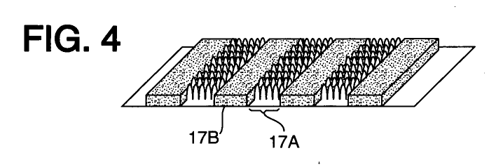

FIG. 4 is a perspective diagram that shows an exemplary fluid guiding surface in accordance with an exemplary embodiment of the invention in which an elongate directional band is formed by means of a thin film and relief structure. As shown in FIG. 4, it is possible to form elongate directional bands A and B by appropriately integrating thin film 17B and relief structure 17A.

The aspect ratio of the relevant relief structure is preferably in the range 0.5-3. When the aspect ratio is less than 0.5, the effectiveness of the change in contact angle by means of the relief structure may be reduced, and the degree of freedom of materials selection to obtain the desired water contact angles may be reduced. Furthermore, when the aspect ratio exceeds 3, the practical cost-effectiveness may be reduced to the extent that the change in contact angle resulting from the relief structure may reach a plateau.

Furthermore, in the fluid guiding surface of the present invention, it is preferable that elongate directional bands A and/or elongate directional band B be built with flat thin film having a thickness of 400 nm or less. When the thin film thickness exceeds about 400 nm, transparency may degrade due to optical reflection and interference effects, and visible discoloration of the fluid guiding surface may occur.

Moreover, in the fluid guiding surface of the present invention, it is preferable that the period (pitch length of the concave portion or convex portion) that defines the concave cross-section, convex cross-section, or concavo-convex cross-section of adjoining concave and convex surface relief structures, to be about 400 nm or less. Even when the relevant period exceeds 400 nm, transparency is degraded due to optical reflection/interference on the surface, so interference fringes and discoloration may become visible.

The relief structure on the surface of the fluid guiding surface may be particularly effective for directing a fluid along that surface, when, for example, it is applied to an automotive component for which visibility is important, such as a window glazing material (e.g. a windshield). Furthermore, by incorporating a relief structure with the abovementioned period into the fluid guiding surface, not only does it become possible to control the direction of the movement of droplets, but it also becomes possible to provide a reflection-resistant or anti-reflection surface on the glazing material, and the like.

Moreover, in the fluid guiding surface of the present invention, elongate directional bands A and/or elongate directional band B are not limiting examples of fluid directing surfaces, and it is therefore possible to use a mixture of inorganic and organic materials and/or an inorganic-organic compound. For example, it is possible to form these by arbitrarily combining inorganic materials such as ceramics of glass, metal, or metallic oxide, and organic materials such as plastic. In fluid directing surfaces, when applying the fluid guiding surface of the present invention to water-repellent automotive glazing materials, glass and plastic can suitably be used. The glass or plastic may be colored or tinted, and need not be transparent.

Furthermore, in the fluid guiding surface of the present invention, the surface of the substrate or base itself may be processed, making it possible to form elongate directional bands A and elongate directional band B directly on the substrate surface. Moreover, by incorporating a coating on the surface of the substrate or base, it may be possible to form elongate directional bands A and elongate directional band B as a thin, permanent or removable coating on the substrate or base. In addition, it may be possible to form elongate directional bands A and elongate directional band B by processing the surface of the substrate or base itself, incorporating a concave portion, and filling other materials in the concave portion as so-called inlays.

In addition, in the fluid guiding surface of the present invention, it is preferable to use the surface after tilting it 5°-85° from level. When the incline angle is less than about 5°, the transfer rate of droplets may be insufficient. Furthermore, when the incline angle exceeds about 85°, it may not be necessary to use a fluid guiding surface according to the present invention, as the droplets may not adhere to the surface, and may spontaneously run off of the surface under an external force such as gravity.

The production method of the fluid guiding surface according to embodiments of the present invention is not particularly limited, and it is possible, for example, to produce fluid guiding surfaces using the following methods and their equivalents. Suitable methods of applying a material to create a composition or surface energy gradient include various coating methods such as roll coating, knife coating, plasma deposition, chemical vapor deposition, sputtering, spray coating, micro- or nano-embossing, microcontact printing such as electrophotographic printing or inkjet printing, and the like.

In some embodiments, multiple application devices (e.g. atomizers, plasma deposition units, chemical vapor deposition stations, and the like) may be arranged serially (e.g. linearly or radially in-line) so that the elongate directional band surface is exposed to different application devices applying compositionally distinct coating compositions along the long axis direction of the elongate directional band.

It may be possible to obtain the fluid guiding surface of the present invention by suitably applying a water-repellent surface treatment and/or hydrophilic surface treatment to the base surface or elongate directional bands A and/or elongate directional band B. Here, the water-repellent surface treatment is not particularly limited, and it is possible to give examples of contact angles of water at 20° C. of 100° or more using polymer materials that include high surface energy materials such as polytetrafluoroethylene and silicone in a composite matrix, and/or surface functional groups such as Nanos B (manufactured by T&K Inc., Iwate, Japan) and Novec E GC-1 720 (manufactured by Sumitomo 3M Ltd., Tokyo, Japan).

Furthermore, the choice of a hydrophilic surface treatment to provide a fluid directing surface is not particularly limited, and it is possible to cite as examples of suitable materials those on which water forms a contact angle of 80° or less at 20° C., including polyamides and titanium oxide. Using these materials, it is possible to apply a water-repellent surface treatment to produce elongate directional bands A, and a hydrophilic surface treatment to produce elongate directional bands B, and thus to specify the desired contact angle or contact angle gradient for each surface.

In addition, it may be possible to obtain the fluid guiding surface of the present invention by forming elongate directional bands A and/or elongate directional band B using a mass transfer method. An example of a suitable mass transfer method is provided by nano-imprinting (e.g. nano-embossing) or micro-imprinting (e.g. micro-embossing) using microscopic metal casts with hot embossing and UV hardening methods, although the invention is not limited to these particular methods. Furthermore, in the case of forming an elongate directional band by means of nano-imprinting, the surface of the base itself may be processed to form the desired directional bands having a desired pattern and surface relief structure. Moreover, it may be possible to simultaneously perform integration of hardened resin with the base at the time of UV radiation or heating after filling a transparent mold made of quartz, etc., with UV hardened resin or thermoplastic resin.

In other embodiments, it may be possible to obtain the fluid guiding surface of the present invention by forming elongate directional bands A and/or elongate directional band B using micro-contact printing. Here, it is possible to cite examples of micro-contact printing as in the transfer of thin films of ink or paint as a stamp of rubber-like material, but the invention is not limited to this particular method.

In yet other embodiments, it may be possible to obtain the fluid guiding surface of the present invention by forming elongate directional bands A and/or elongate directional band B using the ink-jet method of spray-painting microscopic droplets, for example.

When manufacturing the fluid guiding surface according to methods such as these, it may be possible to form fluid directing surfaces having a large area. Also, because it is possible to remarkably shorten the amount of time of formation compared to semi-conductor fabrication methods involving lithographic, electron beam, plasma discharge or vapor deposition methods, it may be possible to reduce the manufacturing cost of the fluid guiding surface compared to these plan for cost reduction. Furthermore, it may be possible to obtain the fluid guiding surface of the present invention by suitably combining the abovementioned production methods.

The present invention will be explained in further detail by means of embodiments and comparative examples, but the present invention is not limited to these embodiments.

### EXAMPLE 1

The fluid guiding surface of the present example was obtained by forming a repeating structure with a pattern width of 10 μm and pattern pitch of 10 μm as shown in FIG. 3A as having a 1.0 aspect ratio on the surface of PTFE (contact angle of water on 104°) by means of hot embossing. The contact angle on the fluid directing surface on which the repeating structure was formed was measured to be 123°, and the difference in contact angles with the fluid directing surface on which it was not formed was 19°. In addition, the “pattern pitch” is the distance between the pattern width axes (corresponds to P in FIG. 2A). Furthermore, the “contact angle” is the static contact angle measured by Kyowa Interface Science-made CA-A measurement equipment (described below).

### EXAMPLE 2

The fluid guiding surface of the present example was obtained by forming a repeating structure with a pattern width of 10 μm and pattern pitch of 10 μm as shown in FIG. 3A with a 2.0 aspect ratio on the surface of PTFE (contact angle of water on 104°) by means of hot embossing. The contact angle of water on the fluid directing surface in which the repeating structure was formed was measured as 173°, and the difference in contact angle with the fluid directing surface for which the repeating structure was not formed was 69°.

### EXAMPLE 3

The fluid guiding surface of the present example was obtained by forming a repeating structure with a pattern width of 10 μm and a pattern pitch of 10 μm as shown in FIG. 3A as having a 1.0 aspect ratio on the surface of PMMA (contact angle of water on 74°) by means of hot embossing. The contact angle with the fluid directing surface on which a repeating structure was formed was measured as 52° and the difference in contact angle with fluid directing surfaces on which it was not formed was 22°.

### EXAMPLE 4

The fluid guiding surface of the present example was obtained by forming a repeating structure with a pattern width of 10 μm and pattern pitch of 10 μm as shown in FIG. 3A with an aspect ratio of 1.5 on the surface of PMMA (contact angle of water on 74°) by means of hot embossing. The contact angle with the fluid directing surface on which a repeating structure was formed was measured as 29° and the difference in contact angle with fluid directing surfaces on which it was not formed was 45°.

### EXAMPLE 5

The fluid guiding surface of the present example was obtained by forming a repeating structure with a pattern width of 10 μm and pattern pitch of 10 μm as shown in FIG. 3A with an aspect ratio of 1.0 on the surface of nylon 66 (contact angle of water on 65°) by means of hot embossing. The contact angle with the fluid directing surface on which a repeating structure was formed was measured as 19° and the difference in contact angle with fluid directing surfaces on which it was not formed was 46°.

### EXAMPLE 6

The fluid guiding surface of the present example was obtained by forming a repeating structure with a pattern width of 10 μm and pattern pitch of 10 μm as shown in FIG. 3A with an aspect ratio of 1.0 on the surface of polyethylene terephthalate (contact angle of water on 71°) by means of hot embossing. The contact angle with the fluid directing surface on which a repeating structure was formed was measured as 43° and the difference in contact angle with fluid directing surfaces on which it was not formed was 28°.

### EXAMPLE 7

The fluid guiding surface of the present example was obtained by forming a repeating structure with a pattern width of 10 μm and pattern pitch of 10 μm as shown in FIG. 3A with an aspect ratio of 1.0 on the surface of the polyethylene terephthalate (contact angle of water on 71°) by means of hot embossing, and then applying water-repellent coating (Fluoro Technology-made FS-1010, contact angle of water on 118°) on the fluid directing surface on which a repeating structure was formed. The contact angle with the fluid directing surface on which a repeating structure was formed was measured as 165° and the difference in contact angle with fluid directing surfaces on which it was not formed was 94°.

### EXAMPLE 8

The fluid guiding surface of the present example is obtained by placing 1 g of fluoroalkylsilane (CF₃(CF₂)₇CH₂CH₂Si(OCH₃)₃), 48 g of isopropyl alcohol, and 1 g of 60% nitric acid into a beaker, and the contents sufficiently agitated at room temperature. The fluid guiding surface of the present example is obtained by firing for 30 minutes in an oven at 250° C. after applying a polydimethylsiloxane-made stamp with band-like patterning, pressing on a silicon wafer rinsed for 20 seconds with diluted hydrofluoric acid, and transferring a band-like pattern such as is shown in FIG. 2A with a pattern width of 50 μm and pattern pitch of 50 μm. The contact angle of water on the fluoroalkylsilane fluid directing surface was measured as 112°, and the contact angle of water on the silicon wafer fluid directing surface that did not undergo printing was 7°, resulting in a difference in contact angles of 105°.

### EXAMPLE 9

The fluid guiding surface of the present example is obtained by placing 1 g of fluoroalkylsilane (CF₃(CF₂)₇CH₂CH₂Si(OCH₃)₃), 48 g of isopropyl alcohol, and 1 g of 60% nitric acid into a beaker, and the contents sufficiently agitated at room temperature. The fluid guiding surface of the present example is obtained by firing for 30 minutes in an oven at 250° C. after using an ink-jet device on a silicon wafer rinsed for 20 seconds with diluted hydrofluoric acid and applying a band-like pattern such as is shown in FIG. 2A with a pattern width of 200 μm and pattern pitch of 200 μm. The contact angle of water on the fluoroalkylsilane fluid directing surface was measured as 112°, and the contact angle of water on the silicon wafer fluid directing surface that did not undergo printing was 7°, resulting in a difference in contact angles of 105°.

### COMPARATIVE EXAMPLE 1

The fluid guiding surface of the present example is formed with a repeating structure having a 10-μm-wide and 10-μm-pitch pattern as shown in FIG. 3A with a 0.5 aspect ratio on the surface of PTFE (104° contact angle) formed by means of hot embossing. The contact angle of water on the fluid directing surface forming the repeating structure is measured at 110°, and the difference in contact angle with respect to the substrate bearing no fluid guiding surface was 6°.

### COMPARATIVE EXAMPLE 2

The fluid guiding surface of the present example is obtained by forming a repeating structure with a 10-μm wide, 10-μm pitch pattern as shown in FIG. 3A with a 0.5 aspect ratio on the surface of PMMA (contact angle of water on 74°) by means of hot embossing. The contact angle of water on the fluid directing surface on which the repeating structure was formed was measured at 67°, and the different in the contact angle with the fluid directing surface that was not formed was 7°.

The polar component (γ_{BS}) of the surface tension of droplets in which the difference in contact angle of water on each example and the side in which the contact angle is small is shown in Table 1. The magnitude of γ_{BS} in Table 1 was measured according to the method described above using Equation (6).

Performance Evaluation (Drip Test). 10 μl drops were dropped on the sample surface (patterning direction: slant 45° (See FIG. 1D)), the base on which the sample is resting is inclined to a certain degree, the sample angle at which the drops begin to move is measured, and the direction of movement of droplets is observed.

TABLE 1

| | | | | Angle of Base | |
|---|---|---|---|---|---|
| | | | | Relative to | |
| | | | | Horizontal at | |
| | | Contact | | Which Drop | Direction |
| | | angle | | Begins to Fall | of |
| | | (degrees) | γBS (mN/m) | (degrees) | Movement |
| Example | 1 | 19 | 2.1 | 44 | Δ |
| | 2 | 69 | 2.1 | 27 | ◯ |
| | 3 | 22 | 0 | 44 | Δ |
| | 4 | 45 | 0 | 33 | ◯ |
| | 5 | 46 | 1.4 | 33 | ◯ |
| | 6 | 28 | 0.6 | 46 | Δ |
| | 7 | 94 | 0.6 | 20 | ◯ |
| | 8 | 105 | 2 | 15 | ◯ |
| | 9 | 105 | 2 | 15 | ◯ |
| Comparative | 1 | 6 | 2.1 | 46 | X |
| Example | 2 | 7 | 0 | 20 | X |

The results are compiled in Table 1. In addition, within the “direction of movement on droplets” in Table 1, “∘” falls within a 45° pattern, “Δ” does not fall within a 45° pattern but does fall perpendicularly, and “×” falls perpendicularly by gravity. From Table 1, one can see how Examples 1-9, which are within the scope of the present invention, are able to control the direction of movement of liquid droplets on a surface bearing elongate directional bands.

Various embodiments of the invention have been described. These and other embodiments are within the scope of the following claims.

1. A fluid guiding surface comprising:
a first elongate directional band A on a substrate, wherein a surface energy of a surface of the first elongate directional band A exhibits a first water contact angle ^{θ}_{A} at 20° C.; and
a second elongate directional band B proximate the first elongate directional band A on the substrate, wherein a surface energy of a surface of the second elongate directional band B exhibits a second water contact angle ^{θ}_{B} at 20° C.,
wherein the difference ^{θ}_{A}-^{θ}_{B} between the first water contact angle on the surface of directional band A and the second water contact angle on the surface of directional band B is between 10°-140°.

2. The fluid guiding surface according to claim 1, wherein the surface energy of the surface of the first elongate directional band A is greater than the surface energy of the surface of the second elongate directional band B.

3. The fluid guiding surface according to claim 2, wherein the surface energy of the surface of the second elongate directional band B exhibits a calculated polar component of the surface energy γ_{BS} of about 10 mN/m or less.

4. The fluid guiding surface according to claim 1, wherein the surface of the first elongate directional band A and the surface of the second elongate directional band B each define a shape exhibiting a long axis dimension and a short axis dimension.

5. The fluid guiding surface according to claim 4, wherein the shape of the surface of the first elongate directional band A and the shape of the surface of the second elongate directional band B is selected from the group consisting of rectangular, triangular, and trapezoidal.

6. The fluid guiding surface according to claim 4, wherein the first elongate directional band A terminates at a first end and a second end distal from the first end;
further wherein the second elongate directional band B terminates at a first end proximate the first end of first elongate directional band A, and at a second end distal from the first end of directional band B and proximate the second end of directional band A; and
wherein the short axis dimension of the first elongate directional band A at its first end is less than the short axis dimension of the first elongate directional band A at its second end.

7. The fluid guiding surface according to claim 6, wherein the short axis dimension of the second elongate directional band B at its first end is larger than the short axis dimension of the second elongate directional band B at its second end.

8. The fluid guiding surface according to claim 6, wherein the surface energy of the second elongate directional band decreases in a gradient from a first value at its first end to a lower second value at its second end.

9. The fluid guiding surface according to claim 8, wherein the gradient is selected from the group consisting of a linear variation, a logarithmic variation, and an exponential variation with distance from the first end.

10. A fluid guiding surface according to claim 1, wherein the first elongate directional band A and the second elongate directional band B are arranged substantially in parallel.

11. A fluid guiding surface according to claim 1, wherein a bandwidth of at least one of the first elongate directional band A and the second elongate directional band B is 500 μm or less.

12. A fluid guiding surface according to claim 1, wherein at least one of the first elongate directional band A and the second elongate directional band B is formed with a surface relief structure.

13. A fluid guiding surface according to claim 12, wherein an aspect ratio of the surface relief structure is between 0.5-3.

14. A fluid guiding surface according to claim 12, wherein a cross-section of the surface relief structure is selected from one of a concave cross-section, a convex cross-section, or an adjoining concavo-convex cross-section, and wherein the width of the selected cross-section is about 400 nm or less.

15. A fluid guiding surface according to claim 1, wherein at least one of the first elongate directional band A and the second elongate directional band B is formed as a thin film, and wherein a thickness of the thin film is 400 nm or less.

16. A fluid guiding surface according to claim 1, wherein at least one of the first elongate directional band A and the second elongate directional band B comprises at least one material selected from the group consisting of inorganic, organic, and inorganic-organic compounds.

17. A fluid guiding surface according to claim 1, wherein at least one of the first elongate directional band A and the second elongate directional band B comprises at least one material selected from the group consisting of glass, plastics, metals, and ceramics.

18. A fluid guiding surface according to claim 1, wherein the first elongate directional band A and the second elongate directional band B are formed by providing a coating on at least a portion of a surface of a substrate.

19. A fluid guiding surface according to claim 1, wherein the surface is used while the surface is tilted from a level position at an angle of from about 5° to about 85°.

20. A fluid guiding surface according to claim 1, wherein at least one of the first elongate directional band A and the second elongate directional band B is processed with at least one of a water-repellent surface treatment or a hydrophilic surface treatment.

21. A fluid guiding surface according to claim 1, wherein at least one of the first elongate directional band A and the second elongate directional band B is formed by a transfer method.

22. A fluid guiding surface according to claim 1, at least one of the first elongate directional band A and the second elongate directional band B is formed by micro-contact printing.

23. A fluid guiding surface according to claim 1, wherein at least one of the first elongate directional band A and the second elongate directional band B is formed by an ink-jet printing method.

24. A fluid guiding surface comprising:
a plurality of elongate directional bands A positioned on a surface of a substrate, wherein a surface energy of the surface of the elongate directional bands A is such that water exhibits a first contact angle ^{θ}_{A} at 20° C.;
a plurality of elongate directional bands B positioned on the surface of the substrate, wherein each elongate directional band B is positioned adjacent to at least one of the elongate directional bands A to form an arrangement of alternating directional bands A and B, and wherein a surface energy of the surface of the elongate directional bands B is such that water exhibits a second contact angle ^{θ}_{B} on directional band B at 20° C.; and
wherein the difference ^{θ}_{A}-^{θ}_{B} between the first contact angle of water on directional bands A and the second contact angle of water on directional bands B is from about 10° to about 140°.

25. A fluid guiding surface according to claim 24, wherein the arrangement of alternating directional bands A and B defines a band pattern selected from the group consisting of a linear pattern, a V-shaped pattern, and an X-shaped pattern.

26. A method of making a fluid guiding surface, comprising:
forming a plurality of elongate directional bands A positioned on a surface of a substrate, wherein a surface energy of the surface of the elongate directional bands A is such that water exhibits a first contact angle ^{θ}_{A} at 20° C.;
forming a plurality of elongate directional bands B positioned on the surface of the substrate, wherein each elongate directional band B is positioned adjacent to at least one of the elongate directional bands A to form an arrangement of alternating directional bands A and B, and wherein a surface energy of the surface of the elongate directional bands B is such that water exhibits a second contact angle ^{θ}_{B} on directional band B at 20° C.; and
wherein the difference ^{θ}_{A}-^{θ}_{B} between the first contact angle of water on directional bands A and the second contact angle of water on directional bands B is from about 10° to about 140°.

27. A vehicle comprising a fluid control surface made according to the method of claim 26.
